(19) United States
(12) Patent Application Publication
(10) Pub. No.: US 2012/0161428 A1
(43) Pub. Date: Jun. 28, 2012

(54) Protective Holding Strap System

(76) Inventors: Dawn Thurman, Bowie, MD (US); Zikomo Thurman, Bowie, MD (US); Warren Waddell, Laurol, MD (US); LaTonya Waddell, Laurel, MD (US)

(21) Appl. No.: 12/975,744

(22) Filed: Dec. 22, 2010

(51) Int. Cl. B60R 22/00

(52) U.S. Cl. 280/801.1

(57) ABSTRACT

A system for securing a person while in a vehicle is disclosed. A flexible strap member having at least a first end and a second end, wherein the first end is configured to receive a wrist of a person and the second end is configured to receive a hand of the person. The flexible strap member is made of a slide resistant material.

### FIELD OF THE INVENTION

The present invention relates to a protective holding strap system.

### BACKGROUND OF THE INVENTION

Generally people all over the world take some form of transportation such as an airplane, car, bus or train when traveling from one destination to another. Frequently, people take public forms of transportation such as a bus or a train. When they get on the trains or buses they usually have to hold onto some kind of pole or railing in order to keep themselves steady as the bus or train moves from one location to another.

The problem with the people or commuters holding onto these poles or railings is that often times these poles or railings serve as a holder of many kinds of diseases and viruses that may make the commuter sick. Also, if the commuter holds the railing with her hands she may tend to slip because her hands slide off the railing. In order to protect the commuter from diseases or viruses she may obtain from touching the poles or railings, there is a need for a device that is able to limit the contact a commuter has with diseases and/or viruses. In addition, in order to prevent the commuter's hands from sliding off the rails where she may injure herself there is a need for a system that will stabilize the commuter so she may not slide on the railing or pole. Therefore, there is a need for a system that easily protects a commuter from contracting diseases and/or viruses, which is also able to stabilize the commuter so she will not injure herself as she holds onto the pole or railing.

### SUMMARY OF THE INVENTION

The present invention has been accomplished in view of the above-mentioned technical background, and it is an object of the present invention to provide a protective holding strap system.

In a preferred embodiment of the invention, a system for securing a person while in a vehicle is disclosed. A flexible strap member has a first end and a second end, wherein the first end is configured to receive a wrist of a person and the second end is a distal end. The flexible strap member is made of a slide resistant material.

In another preferred embodiment of the invention, a system for securing a person while in a vehicle is disclosed. A flexible strap member having at least a first end and a second end, wherein the first end is configured to receive a wrist of a person and the second end is configured to receive a hand of the person. The flexible strap member is made of a slide resistant material.

In yet another preferred embodiment of the invention, a method for utilizing a protective strap is disclosed that includes: providing a flexible strap member having a first end and a second end, wherein the first end is configured to receive a wrist of a person and the second end is a distal end; inserting the wrist of the person through the first end of the flexible strap member; placing the flexible strap member over a railing; and extending a hand of the wrist of the person through the first end to hold onto the distal end.

### BRIEF DESCRIPTION OF THE DRAWINGS

These and other advantages of the present invention will become more apparent as the following description, is read in conjunction with the accompanying drawings, wherein:

FIGS. 1A and 1B shows illustrations of a protective holding strap system in accordance with the invention;

FIG. 2 is art illustration of how the strap system of FIG. 1 is utilized on a vehicle in accordance with the invention;

FIG. 3 is flow-chart that shows how the strap system of FIG. 1 is utilized in accordance with the invention;

FIG. 4 is another illustration of how the strap system of FIG. 1 is utilized in accordance with the invention;

FIG. 5 shows how the strap system is used on a bus in accordance with the invention;

FIG. 6 shows how the strap is used in an automobile in accordance with the invention; and

FIG. 7 is a flow-chart that shows how the strap system of FIG. 1 is utilized in an automobile in accordance with the invention;

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

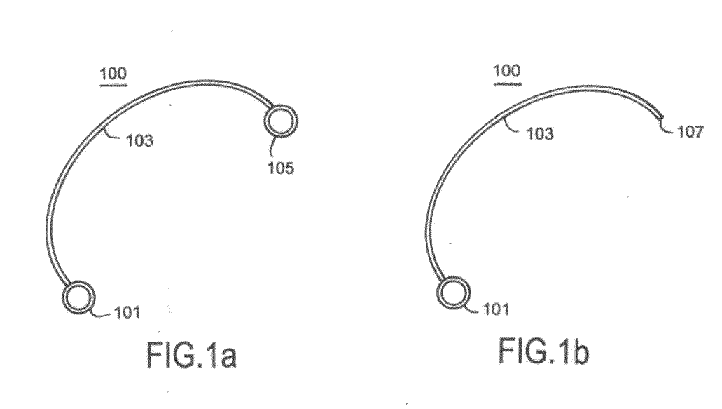

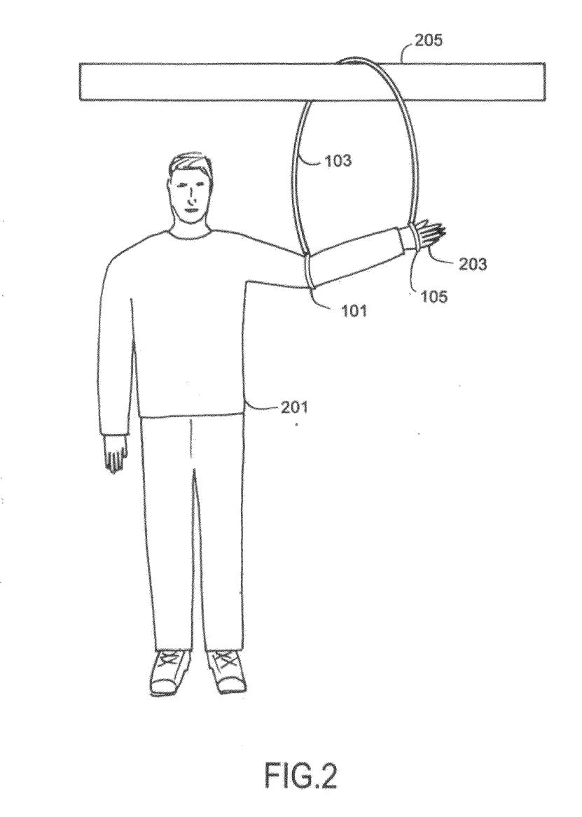

FIG. 1A shows an illustration of the protective holding strap system. A protective holding strap system 100 includes a middle portion 103 of the holding strap system 100 in between a first end 101 and a second end 105. Protective holding strap system 100 may be an elongated elastic flexible strap that may have a length in the range of 3-10 feet. The protecting holding strap system 100 may be a disinfectant strap system that is hypo-allergenic which may be able to protect a human person or commuter from contracting diseases and/or viruses. The protective holding strap system 100 may be made of a plastic or a rubber material. First end 1W is an expandable holding structure, which is able to receive a person's wrist and expand and contract to the size of the person's wrist. The person's wrists will be able to slide into the first end 101 where the wrist will rest there comfortably. The first end 101 may have any type of structure such as a circular structure, a rectangular structure, a hexagonal structure etc able to receive and hold the wrist of the person 201. Second end 105 is a distal end of the flexible strap 100. This second end 105 may also be an optional second expanding holding structure, which is able to receive a human person's wrist to expand and tighten or contract to the human person's wrist. Second end 105 equivalent to first end 101 may have a holding structure, such as a circular structure, rectangular structure, hexagonal structure etc. Also, as shown in FIG. 1B another illustration of the flexible strap 100 is shown. Flexible strap 100 includes a second end 107 that can be simply a distal end of the strap 100. Second end 107 is used to hold onto a typical railing (FIG. 2) by a human person's hand after her wrist is inserted through the first end 101.

Referring to FIG. 1A, in between the first end 101 and the second end 105 is the middle portion 103 of the flexible strap 100. Middle portion 103 is made of a non-sliding material that prevents it from sliding or moving from one place to another when it is on a stationary structure, such as a pole or a rail. The non-sliding material of middle portion 103 has a certain frictional force that prevents it from sliding along a rail of the vehicle. The non-sliding material may be made of a dimpled plastic elastometer that has an extremely high coefficient of friction known as Egrips® that is manufactured by Flexible Innovations Ltd., 1120 South Freeway, Ste 132, Fort Worth, Tex. 76104. In another embodiment of the invention, the non-sliding material may be made of a non-slip material of DYCEM® manufactured at Dycem Limited, 83 Gilbane Street, Warwick, R.I. 02886.

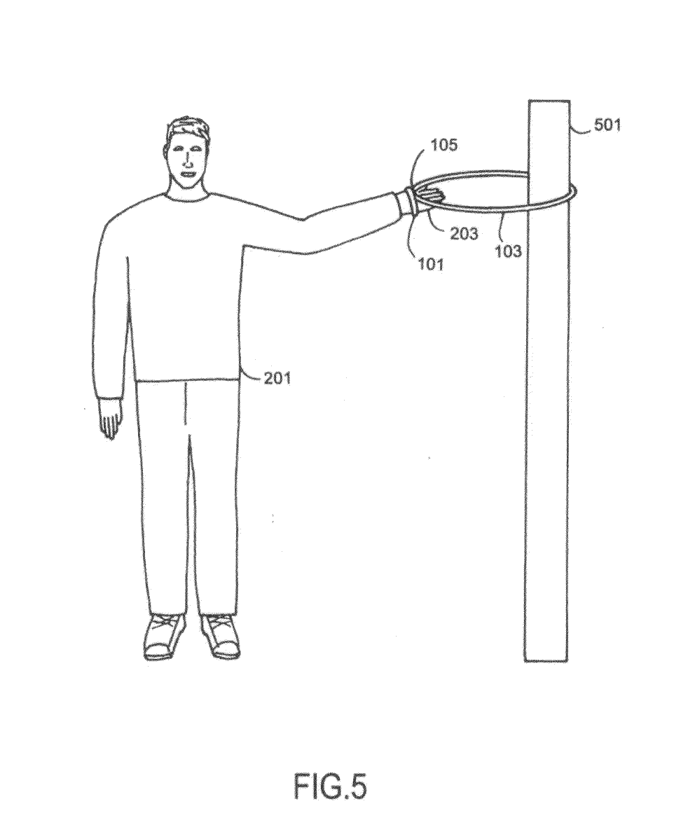

FIG. 2 is an illustration of how the flexible strap system 100 is utilized. In this illustration, a human person 201 utilizes the flexible strap system 100 to hold onto a stationary structure 205 in a vehicle, such as a bus, train, elevated train or subway. Stationary structure 205 is a typical pole or rail in a horizontal position utilized by commuters to stabilize themselves when the bus, train, elevated train or subway is moving. FIG. 5 illustrates all of the same components as FIG. 2; however a rail 501 is positioned in a vertical manner as opposed to the horizontal rail 205 of FIG. 2.

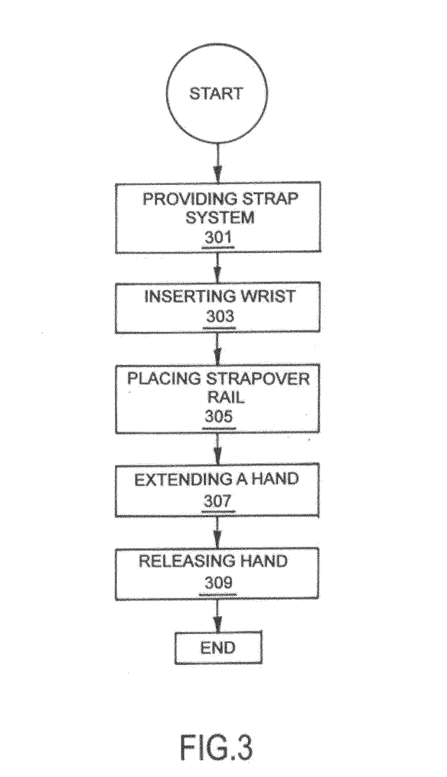

FIG. 3 shows a process for utilizing the flexible strap 100. At block 301, a flexible strap member 100 having the first end 101 and the second end 105 is provided. First end 101 has a holding structure that is able to receive the wrist of the human person 201. Next, at block 303 the wrist of the person 201 is inserted through the first end 101 of the flexible strap system 100.

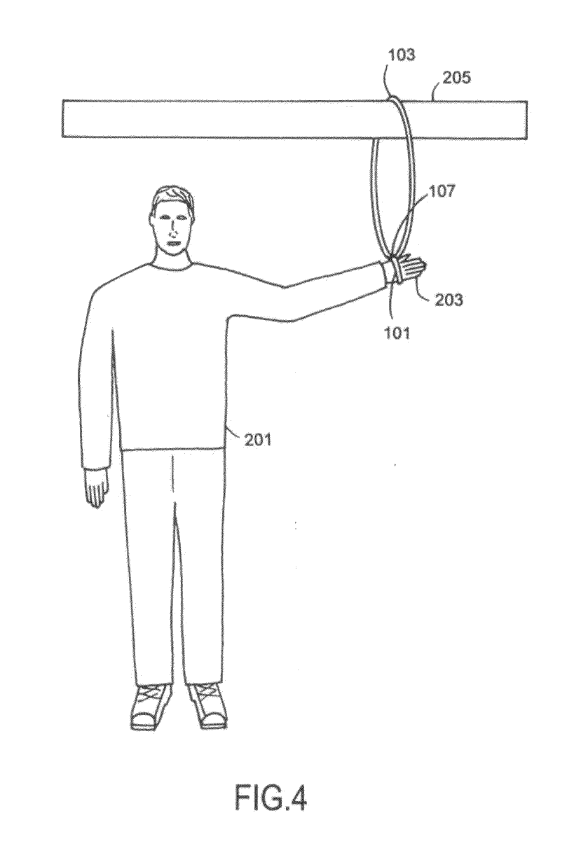

At block 305, the flexible strap system 100 is placed over a stationery structure or a railing 205. (FIG. 2). This railing 205 may be the typical railing found in a public transportation bus, train, elevated train or subway car. Next, at block 307 a hand of the wrist of the person 201 is extended through the first end 101 to hold onto the distal end 105. Distal end 105 may be a holding structure that is able to receive the wrist of the person 201 so the person can hold onto the first end 101 and the distal end 107 in a comfortable fashion. Referring to FIG. 4, another embodiment of the invention is illustrated where all of the components of FIG. 2 are included but the second end 105 is a simple distal end. For FIG. 3, optionally, at block 307 a hand of the wrist of the person 201 is extended through the first end 101 to hold onto the distal end 105 where the hand pulls the distal end 105 to stabilize the person onto the rail 205. The middle portion 103 of the strap system 100 includes the rubber like material described above with a certain frictional force that offers resistance so the human person 201 or consumer will not slide on the railing on the bus or train as it travels from one destination to another.

Further, at block 309 the human person 201 may release the distal end 105 of the flexible strap member 100 when she reaches her destination on the bus or subway and this process ends. The human person 201 may pack up the commuter holding strap 100 and place it into her pocket book or bag then disembarks from the bus or the train.

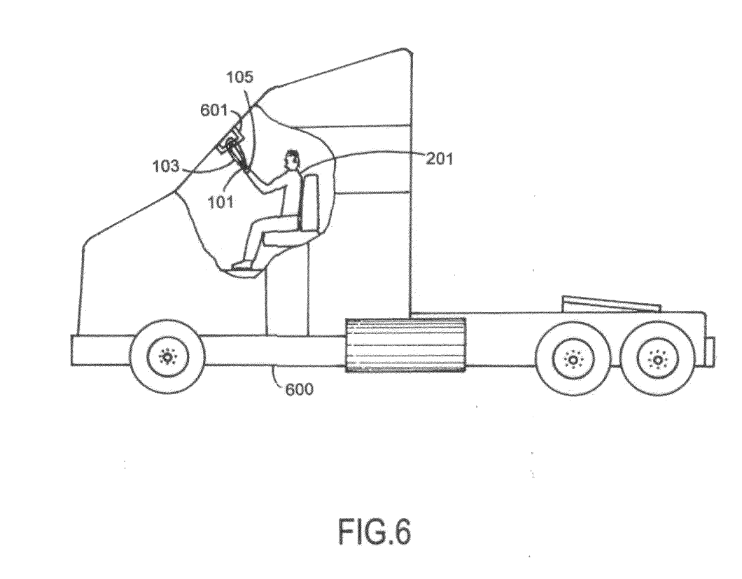

FIG. 6 shows how the strap is used in a car or vehicle in accordance with the invention. In this illustration, a human person 201 utilizes the flexible strap system 100 to hold onto a stationary structure 601 in an automobile 600. In another embodiment of the invention, automobile 600 may also be a truck or any vehicle that includes a holding structure above the passenger side window that is used by a passenger holding on when the driver is driving the vehicle. Stationary structure 601 is a typical passenger side holding structure located above the top portion of the passenger car doors in the front and back of the vehicle. Typically, a person would get into an automobile 600 and hold onto the stationary structure 601 to stabilize her or him as the automobile is being driven.

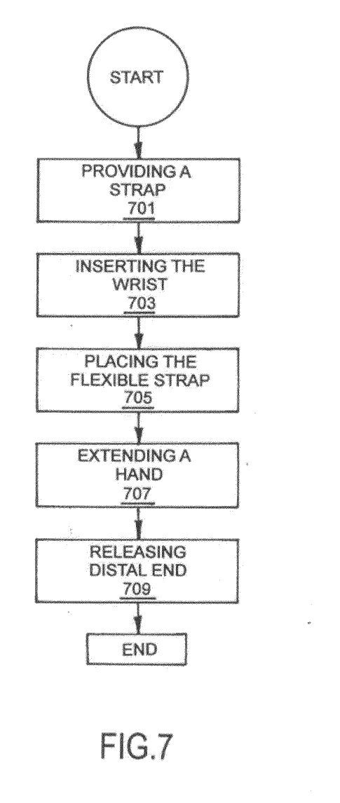

FIG. 7 shows a process for utilizing the flexible strap system 100 in an automobile. At block 701, a flexible strap system 100 having the first end 101 and the second end 105 is provided (FIG. 1A). First end 101 has a holding structure that is able to receive the wrist of the human person 201. Next, at block 703 the wrist of the person 201 is inserted through the first end 101 of the flexible strap system 100.

At block 705, the flexible strap system 100 is placed over a stationery structure 601. (FIG. 6). Next, at block 707 a hand of the wrist of the person 201 is extended through the first end 101 to hold onto the distal end 105. Distal end 105 may be a holding structure that is able to receive the wrist of the person 201 so the person can hold onto the first end 101 and the distal end 105 in a comfortable fashion. In another embodiment, as shown in FIG. 4 the second end 107 is a simple distal end with no holding structure so the human person 201 uses her hand to pull the distal end 107 to secure her to the stationary structure 201. The middle portion 103 of the strap system 100 includes the rubber like non-slide material described above that enables the person 201 or consumer to securely hold onto the railing of the bus or train as it travels from one destination to another.

Further, at block 709 the human person 201 may release the distal end 105 of the flexible strap member 100 when she reaches her destination on the bus or subway and this process ends. The human person 201 may pack up the protective holding strap system 100 and place it into her pocket book or bag then disembarks from the bus or the train.

This invention provides a protective holding strap system that allows a commuter to stabilize herself while riding on a vehicle, such as train, subway, bus or automobile. The protective holding strap system is a flexible strap that has a first end with a holding structure, a middle portion and a second end with another holding structure. The middle portion includes a non-sliding material that prevents it from sliding while it is on a stationary structure. A person is able to insert her wrist through the first end and the second end where the middle portion is placed over the stationary structure of the vehicle. As the person holds onto the first end and the second end she remains stable as the vehicle moves from one location to another because of the non-sliding material of the middle portion of the strap system that prevents the strap system from sliding on the stationery structure. Thus, this invention provides a commuter with a means for securing herself onto a stationary structure of a vehicle so she isn't injured or susceptible to viruses when touching the stationary structure.

What is claimed is:

1. A system for securing a person while in a vehicle comprising:
a flexible strap system having at least a first end and a second end, wherein the first end is configured to receive a wrist of a person and the second end is a distal end; and
the flexible strap system is made of a slide resistant material.

2. The system of claim 1, wherein the flexible strap system includes a rubber like material on a middle portion of the flexible strap system.

3. The system of claim 2, wherein the rubber material is configured to reduce sliding on a stationary structure of the vehicle.

4. The system of claim 3, wherein the stationary structure is a pole.

5. The system of claim 3, wherein the stationary structure is a railing.

6. The system of claim 1, wherein the first end is configured to contract when the wrist of the person is received into the first end.

7. The system of claim 1, wherein first end is configured to tighten around the wrist of the person.

8. The system of claim 1, wherein the flexible strap system is an elongated flexible strap system.

9. The system of claim 1 wherein the vehicle is a train car.

10. The system of claim 1 wherein the vehicle is a bus.

11. The system of claim 1 wherein the vehicle is an automobile.

12. The system of claim 1 wherein the first end has a holding structure.

13. The system of claim 12 wherein the holding structure is a circular structure.

14. The system of claim 1 wherein the second end is another holding structure.

15. The system of claim 14 wherein the holding structure is a circular holding structure.

16. A system for securing a person while in a vehicle comprising:
a flexible strap system having at least a first end and a second end, wherein the first end is configured to receive a wrist of a person and the second end is configured to receive a hand of the person; and
the flexible strap system is made of a slide resistant material.

17. A method for utilizing a protective strap, comprising:
providing a flexible strap system having a first end and a second end, wherein the first end is configured to receive a wrist of a person and the second end is a distal end;
inserting the wrist of the person through the first end of the flexible strap member;
placing the flexible strap member over a railing; and
extending a hand of the wrist of the person through the first end to hold onto the distal end.

18. The method of claim 17, wherein the flexible strap system has a middle portion that is slide resistant.
